(19) United States
(12) Patent Application Publication
(10) Pub. No.: US 2007/0045301 A1
(43) Pub. Date: Mar. 1, 2007

(54) Automatic cooking system and material handling system with multiple motion control mechanism

(76) Inventor: Doddabasava Girish Chandra Kumar, Karnataka State (IN)

Correspondence Address: CHOATE, HALL & STEWART LLP, TWO INTERNATIONAL PLACE, BOSTON, MA, 02110, US

(21) Appl. No.: 10/557,952

(22) PCT Filed: May 23, 2003
(86) PCT No.: PCT/IN03/00195

§ 371 Date: Nov. 22, 2005

(51) Int. Cl. H05B 6/80

(52) U.S. Cl. 219/729

(57) ABSTRACT

This invention relates to an automatic cooking system for automating the cooking process. The said system cooks all kind of possible dishes of any type, composition, and shape. It is entirely an automatic method of cooking. The only requirement for the users would be to bring the food items from the market and load in to ACS. And they just have to choose or instruct which food they want to get cooked. The system makes it possible to get the required dish, amount and quality. It also makes it possible to change the composition of the cooked food for the required content, taste and quality. Also it allows multiple dishes to be cooked at the same time. The user can instruct ACS remotely through a communication link and the food will be cooked ready at the specified time.

This invention relates to an automatic cooking system. Automatic cooking system (ACS) is a system for automating the cooking process. It automates the complete process of cooking. And it cooks all kind of possible dishes of any type, composition, and shape. It is entirely an automatic method of cooking. The only requirement for the users would be to bring the food items from the market and load in to ACS. And they just have to choose or instruct which food they want to get cooked. The system makes it possible to get the required dish, amount and quality. It also makes it possible to change the composition of the cooked food for the required content, taste and quality. Also it allows multiple dishes to be cooked at the same time. The user can instruct ACS remotely through a communication link and the food will be cooked ready at the specified time.

Accordingly, it is the primary object of the present invention to develop a fully automatic cooking system, which can be used for preparing a variety of foods. It is anticipated that the proposed system can be used for cooking all possible variety of dishes available all over the world.

Process and Materials of Cooking:

Cooking consists of the following primary operations:

Storage And Access: Storage of different materials in normal and refrigerated storage. Access the required materials. Measuring the amount of material.

Pre-Processing: Cutting, Mixing, Grinding, Crushing, Filtering, Moving of materials, Separating some quantity, Temporary storage, Shaping, Layering etc.

Auxiliary-Process: Input (loading materials), Measuring (volume/weight/count), Cleaning (materials/system), Water inlet, Heating by appliance (Gas/Electric), Cooked dish outlet, Measured outlet, Waste outlet etc.

Cooking: Water immersed heating, Pan-frying/raw heating, Oil frying, Steam/pressure heating, Hot air heating/microwave etc.

Materials Handled in Cooking:

All the materials used in cooking or human consumables can be categorized in to 3 different states of existence of matter. They are further sub classed for cooking as:

Solids: Solids more than 8 cubic centimeters (based on cell size, discussed later), Solids between 8-1 cubic centimeters (working size range), Solids less than 1 cubic centimeters (grains), Semisolids (soft solids) whose shape gets deformed easily by force, Powders and fine granules.

Liquids: Pastes, Highly viscous liquids (oil like), Regular liquids (water like).

Mixture of solids and liquids: Any combination of sub classes of solids and liquids.

Gas: Gas is mostly not used in kitchen cooking, other than the gas used for heating.

All the materials used for cooking fall in these categories. And Solids have a condition that they can be cut.

Architecture Principle of ACS:

Keeping the above in mind, and also to provide a system, which can simplify the entire cooking process, one possible approach is to have a system, which can do any work, so it can also do cooking. It can be called a generic work handling system. A robot arm method can also be used for work handling. Let's say the arm picks the knife, cuts the bread. And takes the vessel, and gets the materials by opening the plate of the container and so on. In conventional cooking, lots and lots of different work is done for cooking. But, such a system needs extreme precision of the movements; next serious most constraint is, it takes a huge space to operate. And one more reason is, it takes lots of accessories to cook, the entire kitchen wear has to be built in to it. And last problem is the system may become too complex for the robot hand to reach the required point to do any work.

The approach used for ACS is to have an embedded architecture, which can handle any material and is optimized for cooking. It's a generic material handling system. In cooking, materials come in and material go out, so it's basically a material handling system. It will be a compact system, which can handle any material and process them in all possible ways, and its modules are specifically made to do cooking. So it doesn't take many other accessories like bowl, vessel, spoon, or knife, for cooking anymore. Also it optimizes space, operation, and efficiency. Hence cooking is principally not of doing many work, but of processing many materials. So, generic material handling architecture is the one, which will be followed from now on for ACS.

This invention will now be described with reference to the accompanying drawings, wherein:

FIG. 1 illustrates the architecture of the Automatic Cooking System of the present invention;

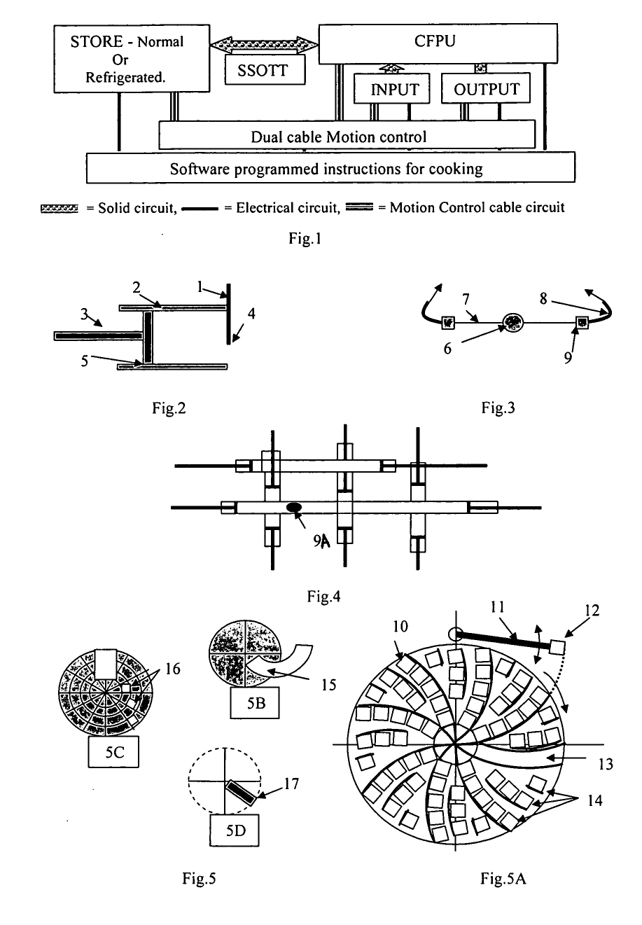

FIG. 2 illustrates the Cell unit;

FIG. 3 illustrates the Motion control dual cable mechanism;

FIG. 4 illustrates the solid circuit unit;

FIG. 5 illustrates the sector, slot, open-close, plates and arrangement of cells in the storage disk;

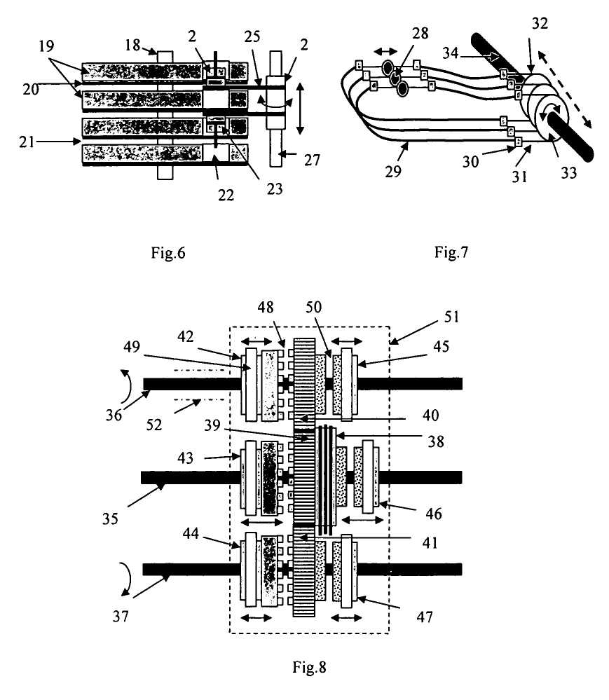

FIG. 6 illustrates the Storage and access mechanism;

FIG. 7 illustrates the Multiple motion control system;

FIG. 8 illustrates the Gear arrangement of 7-state parallel processing motion controller which will be referred to as 7-state “GIRISH BOX”;

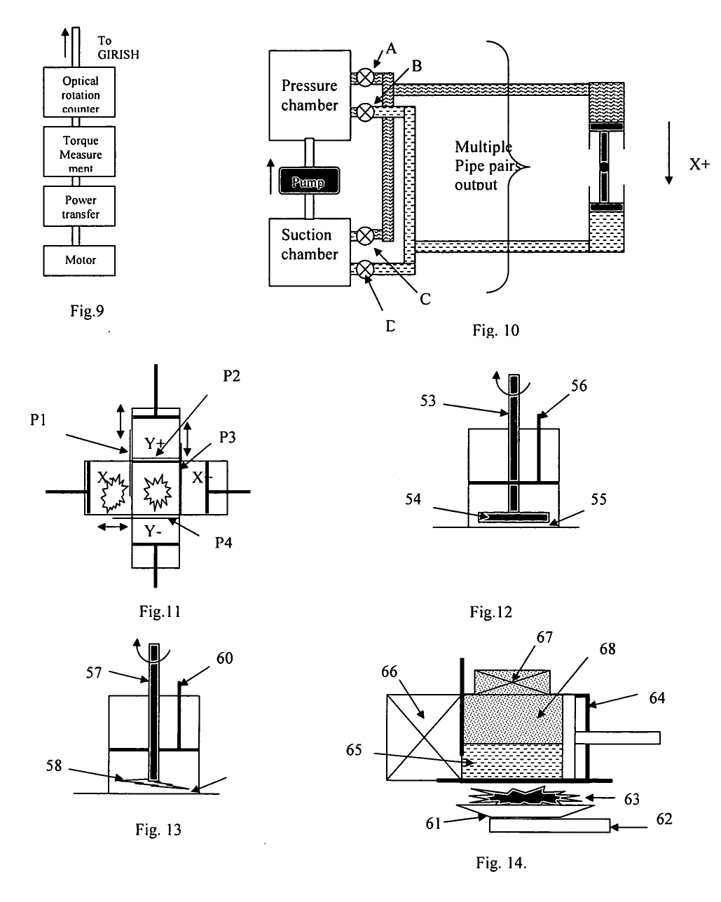

FIG. 9 illustrates the Driving mechanism for the motion controller shown in FIG. 8;

FIG. 10 illustrates the Driving mechanism for the motion controller shown in FIG. 8, which will be operated on Pneumatic principles;

FIG. 11 illustrates the Cutter module used in the automatic cooking system;

FIG. 12 illustrates the Mixer module used in the automatic cooking system;

FIG. 13 illustrates the Grinder module used in the automatic cooking system;

FIG. 14 illustrates the Gas-Steam heating module used in the automatic cooking system;

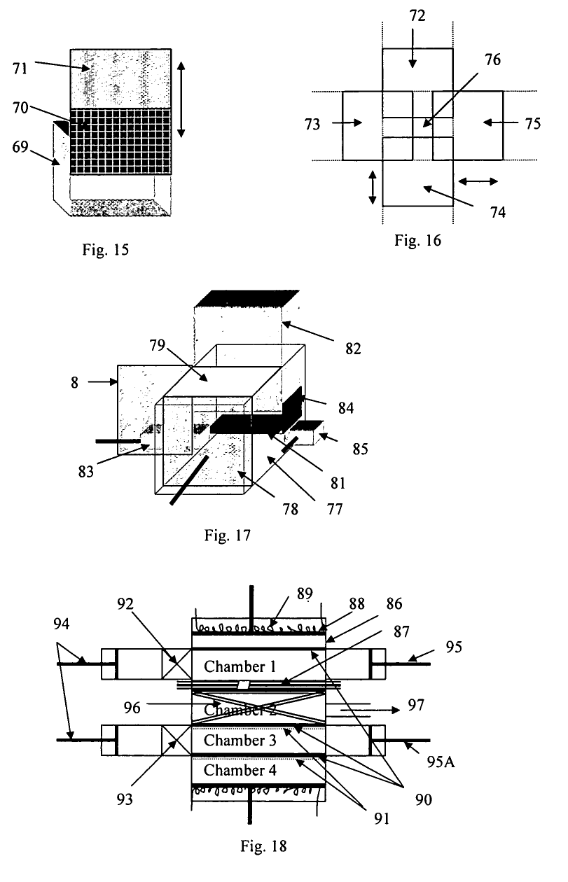

FIG. 15 illustrates the Filter module used in the automatic cooking system;

FIG. 16 illustrates the Window mechanism used in the automatic cooking system;

FIG. 16A illustrates the Multi Shape Design Plate (MSDP) used in the automatic cooking system;

FIG. 17 illustrates the Input module used in the automatic cooking system;

FIG. 18 illustrates the Cooking module integrated with shaping unit used in the automatic cooking system;

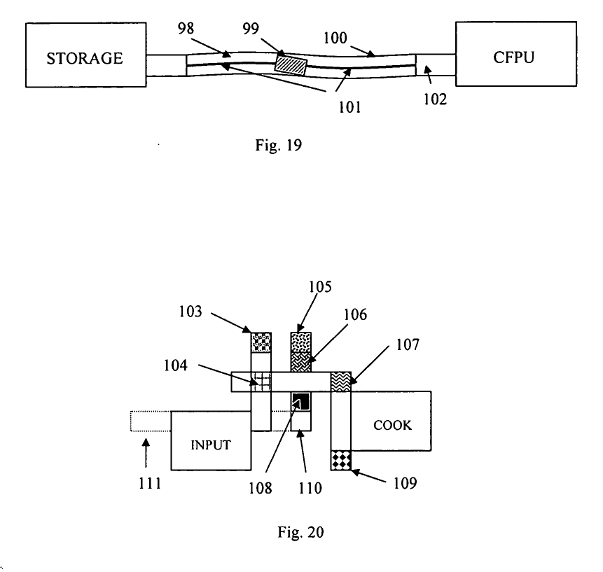

FIG. 19 illustrates the Small Solid Object Transport Tube (SSOTT) module used in the automatic cooking system; and

FIG. 20 illustrates the Central Food Processing Unit (CFPU) Architecture used in the automatic cooking system;

### ARCHITECTURE OF ACS

Based on the above, the architecture of ACS is shown in the FIG. 1. The main modules are:

Store: A Module to store the different materials used for cooking.

CFPU: Central Food Processing Unit, its a module which does all the operations of ACS.

Input: A module for loading all the materials in to ACS.

Output: A module, which outputs the cooked food.

It can be Noted, A computer is a Generic Information handling system. A robot is a generic work handling system. ACS is a generic material handling system.

Design Principles of ACS:

ACS stands on these basic design principles and methods for its operation.

1. Cell for materiel handling.

2. Solid circuit.

3. Motion control by dual cable.

4. Software programmed instructions for cooking.

5. Standardization of all the input materials for ACS.

Cell:

Cell is the basic unit of ACS. It is shown in the FIG. 2. It is basically a piston (3)-cylinder (2) arrangement with an open-close plate (1) in the front. It is used for storing and moving the materials. It is used to do all the basic operations with the materials. The front plate (1) can be opened and closed to get the material in, and keep it closed. The plate (1) has a sharp cutting edge (4) so that it can cut the materials while moving. The piston (3) is used to push the material out of the cell, But to get the material inside the cell, the material has to be pushed in to the cell from the outside. The cell is made mostly as a cube so that the material can be cleanly moved in one direction and taken out in other two directions, although other shapes are possible. Cell can be used for temporary storage, cutting, Crushing, moving the materials, separating some quantity. And other operations like mixing and grinding can be implemented within the cell. And by modifying the plate to include a mesh, we can do the filtering operation. Hence, most of the operation of the ACS can be achieved by the cell. These operations are discussed in further sections.

Solid Circuit:

Solid circuit is like electric circuit. It provides a path for solid objects to move. The key point here is, an external force is applied at every point in the path for the solid objects to move.

Unlike other forms of fluid movement, where things are pressurized to go in the pipe or path, or a ball may be hurled down in a spiral to find its way down in the solid pipe, and gravitational force may be acting at every point for it to move. But in solid circuit, the object is bodily moved by an external agent at every point of its travel. And the force is not the same gradient of force acting in all the points, but entirely controlled and can be different along the path to cause the solid objects to move in a controlled fashion. The key point is, in the solid circuit, a body given at any one point in the circuit can be moved to any other point in the circuit. An example of the solid circuit suited for ACS is shown in the FIG. 4. A solid object or material (9A) as shown in the fig can be directed to move to any given point in the network by appropriately pushing the piston rods. In ACS a piston arrangement is used. Because the material used can be liquid and sticky substance, so for a clean operation, the piston-cylinder arrangement is selected.

Motion Control by Dual Cable:

ACS is mechanically a complex machine, because it is a material processing system. It has to do things like Cutting, Moving of materials etc. So a generic mechanism is needed for doing many mechanical works. The idea is to use dual inner (7)-outer (8) cable mechanism, as shown in FIG. 3. Consider any object (6) to be moved, we can attach or fasten two inner cables on it, and fix the outer cables on a rigid support, and by pulling the inner cables in opposite directions the motion of the required point can be controlled. Accordingly all the points, which required to be moved, are connected with such cable pairs. So now there is a need for many multiples of such cables, which have to be moved independently. The solution is to have a common system where all such cables are connected and controlled. Such arrangement frees the forcing system from being closely embedded with the working system. Such a system, which makes, multiple, independent, motion control possible, simultaneously, will be known as “GIRISH”. Box. It is a generic device for all mechanical motion control systems. It is discussed in further sections.

Software Programmed Instructions for Cooking:

All the motion in the solid circuit and all the operations of ACS are carried out by the force transferred by the cables. So, if is required to instruct all these to cause movements and operations in order to cook any dish. Hence computer instructions or software programs are needed to carry out the operations. And finally, to instruct the system that, it is this particular dish, which needs these and these materials at these quantities and it has to be processed in these particular order etc, and this is how it has to be cut, mixed and cooked, has to be programmed accordingly.

Standardization of all the Input Materials for ACS:

Every substance of material used as input to the ACS must be uniquely defined and coded. So this particular requirement calls for a tremendous amount of standardization of all the kind of food materials we load them as input. Any cooking program written has to first know what material it is handling. So that it can be accordingly programmed to process. So, one simple way to standardize all the materials is to list out all the common materials used for cooking and give them a unique code number. So, with the given code number the software can deal with the correspondingly mapped material. The next improvement that can be made is, to number close group of materials with close sequence of numbers, so that programs can deal with a group of materials.

Storage Mechanism:

Here we consider a very efficient storage and access mechanism for solid materials whose maximum size is less than the cell size, it is used for storing and accessing cooking materials. Consider a disk, as shown in FIG. 5A. The disk is mounted on the axis at the center, and is free to rotate. The disk has vertical partition walls of cubes or cells (10) of same size, with as many possible cells packed in. The cubes or cells are placed not exactly in radial out word fashion but as arcs. So that an external arm (11), rotating on an axis outside the disk with a cell (12) at its end, can sweep exactly over the top of the cells. All the cells are placed such that there are many arcs formed. The arcs are rotationally equidistant, so that when the arm swing spans over one arc, the disk can be rotated so that the arm now can swing over the next arc. And by rotating the disk any arc can be made to come in the path of the arm swing. And by selecting the amount of arm swing any particular cell can be selected. The materials are stored in the cells. The attached cell (12) at the end of the arm can get and put the materials in and out of the cells.

The cells of the disk are open at the top and bottom sides, and all the materials are held and selected by a sector, slot, open-close plates, Consider the sector selector plate as shown in FIG. 5B. It is placed closely under the disk, so that it covers the bottom of all the cells, except one row or arc of cells. And the sector selector plate has one row open (15), so that any cell, which needs to be accessed, will make its corresponding arc aligned with this open side of the sector selector plate. The sector selector plate is held stationary, and the disk rotates to get the arcs to come in line with it. Now there are many cells in one arc, which will come under the open side of the sector plate. But we need to select one cell in that arc, so we need a slot selector plate, it is as shown in the FIG. 5C. It has many open slots (16), by rotating the slot selector plate, any particular cell in the arcs can be opened and all the remaining open cells in that arc are closed. So, with the pair of sector selector and slot selector plates, one can access any cell. Now, one more plate is needed, which is an open-close plate as shown in FIG. 5D. As during the process of selection, the cells will be exposed to open area, and even when a cell is selected, one needs to have a control on opening and closing the cell. To achieve this an open close plate (17) is provided. With these plates, one can select any cell and load and unload material in and out of any cell in the disk.

In the above discussion the storage and access of one disk has been discussed, and now the access of three-dimensional storage will be discussed. The three-dimensional storage is an array of disks (19) mounted on one and the same axis (18). Here the key point is the gap between the disks (21) is very small compared to the cell size. This is done to increase the storage density. But then one cannot directly put the solid object of cell size in to any disk. So the access is done in a modified way, as discussed above with reference to FIG. 5A. One sector or one line row (13) of cells in the disk is completely removed and is free space. The arrays of such disks are mounted on an axis as shown in the FIG. 6. To begin with, all the disks are aligned so that their empty row's (22) come in line. The selector plates (20) are aligned so that their open sides comes in line, and slot selector plate also has one open side, which will be aligned in this line, and open close plate is in open position. With this, the line of rows all along the axis of disks is free. With this arrangement, one can reach any disk moving parallel to the axis. And once one reaches the disk below the required disk, the same is rotated, so that its arc is selected, and by moving Sector-slot-open-close plates, one can select the particular cell.

The space required for moving the solid object to a cell of the required disk, is obtained by the open slot of the previous disks The access along the array is done by an arm mechanism (25) as shown in FIG. 6. It has a storing and collecting cell (23), which carries the material from out side and stores in the required cell. It also collects the materials back. A pushing cell (24) just serves the purpose of pushing the materials in to the collecting cell, through the storage cell area. And these two cells are attached to two rods (25), which can pass through the gap between the two disks (21). And the arms are mounted on a slider (26), which can move along the axis (27) and also rotate.

This system is the most compact way of storing and accessing solid materials, which has finite maximum size, which makes it the most suitable and compact way of storing all the groceries of the kitchen. One can store hundreds of different things simultaneously. It is better to store a large quantity of material in multiple numbers of small units than having one large unit for it. Having smaller units allows one to store more number of different things. And large things can anyway be stored in multiples of smaller units. Also having small but same size cells, than having a variable size cells, reduces the complexity of the system and allows easy storage management. The system will have a record of which material is stored in which cell and what is the quantity present in that cell. The system chooses the empty cells and fills up new materials when new materials are loaded in to ACS. The refrigerated storage is nothing but keeping this standard storage system in a refrigerator. Even the materials, which are cooked, can be put back in to normal storage or refrigerated storage. And may if the CFPU does not have enough temporary local space it can put back the materials in to storage while cooking. With this storage, a major module of ACS is covered.

Multiple Motion Control by Dual Cable Mechanism:

In a complex mechanical system, where there are lots of different moving parts operating in the system, one needs an efficient method, which can induce regulated motion on all moving parts. For that, consider, a motor can be fitted to each moving part, but that method is hugely expensive, also the system would become bulky. Such a system may be too complex and one cannot put a motor in the required place or would add lots of belts etc. Then, consider the robotic arm method of motion control. Though it is generic, it has some serious problems such as: 1. The working system could be too big. 2. The working system may be complex, so that the robot arm may not reach the desired points. 3. Robot arm can't hold all things so as to move them. 4. Only one motion is controlled by one robot hand and simultaneous parallel processing cannot be done. So considering a generic nature of the problem, a generic and efficient way of controlling complex mechanical movements in any system is needed. It also needs a driving system, which is independent of the complexity of the working system, a mechanism which allows one to separate forcing system from being closely embedded with the working system. Consider, on the other hand the motion control by dual cable, it is simple, flexible, compact and the cable ends are fitted to the moving things so it is independent of nature of things moving. Multiple and simultaneous motions are possible. So dual cable method is more appropriate for multiple motion control. Such a system will be called or known as “GIRISH” Box. Said Box is a generic work handling system, which can be fit to control all complex mechanical systems, in diverse applications.

Consider the mechanism for one of the cable pair as shown in the FIG. 7. The one end of the inner of the dual cable is connected to the point or the body to be moved (28), the other end be wound on a wheel drum (33), and are tied to a point on the drum, so there is no slip of the cables when the drum is rotating (32). The outer of the cables (29) are fixed on the rigid support (30). Now, when the wheel rotates, the inner cable (31) will cause the point at the other end to move. The length of the displacement of the point is controlled by the amount of rotation of the wheel drum. The direction of movement of the point is changed, by changing the direction of the wheel. And any movement at the distant point is directly mapped to the corresponding rotation of the wheel. So all the kind of movements on the point can be, correspondingly enforced by the wheel drum. And there are many such drums for each cable pair mounted on the same common axis (34). Now we shall consider some of the most common types of movements for motion control, and the mechanism of obtaining them.

Each moving part, or correspondingly its wheel, requires some mode of movement. Its called the state, and the basic states are as listed below,
1. B-C Blocking-clockwise
2. B-AC Blocking-Anti clockwise
3. B-S Blocking-Stop
4. NB-C Non Blocking-clockwise
5. NB-AC Non Blocking-Anti clockwise
6. NB-S Non Blocking-stop
7. Free Free motion.

The clockwise and anti-clockwise indicate the direction of movement. And here, Blocked means no matter what external conditions or load is, the forcing system is made to act to its maximum possible effort to cause motion, and there is no slip. Similarly forced stop means it is locked and reasonably any external force acting on it will not alter the stopped one to cause any movement. Because of this kind of forced action it will be called as blocked. It is a sure move mode or state, in which the displacement is ensured. In Non-blocking state the system tries to cause the motion by applying some force. But the displacement is dependent on the external condition where the force is acted. The non-blocking mode acts as a constant force source on the system. Or as a spring, it can give elastic force, like in spring there is force but something would be holding it, so that it does not expand. Once it is freed it can cause displacement. When such mode of operation is desired, non-blocking mode can be used. In the free state, the body under consideration is left to itself, without any controlling influence, so the body can move freely in the environment it is in.

The FIG. 8 shows a basic element (51) of a 7 state “GIRISH” Box, which can give the above-mentioned mode of motions for one cable pair. It has three shafts (35,36,37). The cable wound drum (38) is attached to gear (39) and is placed on the central shaft (35). It is not fastened to shaft, but free to rotate. The central shaft is fixed and stationary i.e. not rotating. It is the other two shafts on top and bottom, which rotate clockwise and anti-clockwise respectively. And there are gears (39,40,41) on these shafts which, make drum (38) rotate, these gears are not directly connected on their shafts, but instead they have disks (42,43,44,45,46,47) on sides of these rotating gears (39,40,41). The disks can rotate and slide with their shafts, so by sliding the disk 42 alone, one can make the drum rotate in clockwise direction, and by sliding disk (44) alone one can get anti clockwise rotation. And the disk in the middle (43) is not allowed to rotate but only slide, which is used to forcibly stop. As in fig the left side of the rotating disks (42,43,44) make toothed contact (48) with the gears in a positive lock fashion. And the right side disks (45,46,47) make frictional contact (50) with the gears. Along with this, the sliding wheels have toggling arms (49), the arms have bi-stable toggled swings. I.e. the arm can be thrown on either side and can be left in that position. It will remain in that position until it is put back to other position and so on.

By sliding-in or coupling the toothed disk (42) on the clockwise rotating shaft (36) with the gear (40) the drum (38) can be made to rotate in Blocking-clockwise (B-C). Similarly by coupling the toothed wheel (44) with (41) which is on the anti-clockwise rotating shaft (37) one can get Blocking-Anti clockwise (B-AC) rotation. By coupling the toothed wheel (43) of the middle shaft (35) with (39), which is stationary, we can get Blocking-Stop (B-S). And similarly by connecting the frictional wheels (45,46,47) suitably on the gears one can get, Non Blocking-clockwise (NB-C) by coupling (45), Non Blocking-Anti clockwise (NB-AC) by (47), Non Blocking-stop (NB-S) by (46). In all the cases only one arm is in action at a time, by moving all the arms back, the whole drum becomes free (FREE-STATE). And so if there is any force acting on the system then it is allowed to freely rotate. One can have an array (52) of such basic unit (51) for moving multiple cables or wheels on the same set of axis (35,36,37). Any wheel can be made to rotate in any of the states, independent of the movement of the other wheels. So, many of the drums can be made to simultaneously rotate. So, such system is capable of doing many things simultaneously, and so is parallel processing.

The power transfer mechanism for 7 state “GIRISH” Box is as shown in the FIG. 9. Even when there are many drums rotating in different directions and in different amounts, there is still only one motor, driving the set of shafts to rotate the wheel drums on them. Also there is only one rotation counter. The rotation of each drum is counted in the interval starting when its arm is thrown to rotate, till it is stopped, when its arm is thrown back. A torque measurement unit requires to be one for each drum or cable pair, to know how much is the amount of force exerted on each moving body. This could be solved, by having only one torque-measuring unit, with only one torque measurement possible at a time. So effectively this can only be used to detect over load conditions. Another way is, to know the present torque, and without affecting the other modules, note the amount of torque changed with the new drum or cable in action, the difference gives the amount of torque exerted by that cable.

By providing only toothed or frictional set of wheels, one can get a 4-state “GIRISH” Box. It supports B-C, B-AC, B-S, FREE states. One can also get a single processing Trinary “GIRISH” Box, in which only one wheel drum can rotate at a time, and it will support B-C, B-AC, B-S states. By just having one single axis and a rotating wheel on one side and a stopping wheel on the other side both with toothed contacts, the direction is changed by changing the direction of rotation of the axis itself.

One of the key features of 7-state parallel processing “GIRISH” Box is that in Non-Blocking mode any device, which gets blocked due to external condition, will not cause the whole system to stop. Similar to the above one can have N-state “GIRISH” Box. In the N-state “GIRISH” Box, each force acting method could follow some function like the spring, which varies its force along the displacement, etc. And many such forcing units may be connected to cause the rotation of the drum. Or cause the motion of the cables to exert desired kind of force on the system. Or one can have generic forcing system, which causes any kind of force patterns to exert force on the cable pairs. One can collectively use these combinations of states in a single “GIRISH” Box, when needed.

Mechanism of Toggling Multiple Arms:

The toggling arms make up a two-dimensional array, so one can have plane of X-Y, positioner, and also can have a notch projected from such plane, which can toggle the arms on either side. The other way is to have electro-magnets, which can pull the arms. Since there is going to be one electro-magnet for each arm, one doesn't need Bi-stable spring supported arm, but the relay itself can hold the arms during the rotation. The initial or default position of the arms is put to blocked stop state, so that even if the power goes off, the system will not collapse, but remain exactly in that position, even when there is load on it.

Pneumatic “GIRISH” Box:

Though a dual cable method is used in ACS, this is the counter part of dual cable method of multiple motion control. This one uses gases or liquids for the power transfer. It is shown in the FIG. 10. It supports the states, 1. Move Positive, 2. Move Negative, 3. Blocked Stop, 4. Free Motion. It provides, multiple, independent, simultaneous, parallel processing motion control mechanism. It has as in fig, four valves A,B,C,D which can assume the states as in the table below:

Listed below are the allowed working states of the valves:

| | A | B | C | D |
|---|---|---|---|---|
| MOVE POSITIVE | Open | Close | Close | Open |
| MOVE NEGATIVE | Close | Open | Open | Close |
| BLOCKED STOP | Close | Close | Close | Close |
| FREE MOTION | Close | Close | Open | Open |
| FREE MOTION | Open | Open | Close | Close |

Note:
Before Opening any valve, make sure all the valves are closed, i.e. getting in to stop state before moving, or at least the closing ones should be closed before opening valves. This is to avoid any sudden burst of fluids being shorted between pressure and suction chambers.

This makes up our Motion control mechanism, which is a very generic mechanism, not just to make things work in ACS, but it can be used in diverse applications. ACS is one example, which can demonstrate the capability of “GIRISH” Box. It can be used, to get rotation, leaner motion, reciprocal motion, mechanical switching, and by combining with unidirectional clutch one can get continues rotation or linear motion, even though the cables are limited to finite length.

Pre-Processing:

Various pre-processing steps are involved in the process of cooking, which will be discussed hereinafter.

Cutting:

Cutting is the most elementary operation in ACS. Here we will consider a more versatile and robust and simple in operation cutting unit, which can cut and also separate the cut part of the material. It is as shown in the FIG. 11. It's a combination of 7 cells. X+, X−, Y+, Y−, Z+, Z−. Each has a plate, p1,p2,p3,p4,p5,p6, the other two cells in Z direction are not drown in fig for visibility. The material (M) to be cut enters in X− cell, which is pushed in to the middle region during this, the plate P1 can act on the material vertically, causing the material to be cut along the X direction. When the whole of the material is put in the middle region, or only part of the material needs to be further cut which is put in the middle region, is put to Y direction cutting. Similarly pushing on either side of Z-axis we can get the 3^{rd} degree of cutting. The X,Y,Z cutting need not be in full proportion the material can be cut partly along the X axis, and then moved on to cut only that part in the Y direction, and in Z direction. The other important function of this cutter is this does the job of separating some quantity. That is, it can separate the quantity, which is cut for different processing, by moving the material in the adjacent cell the required material can be separated.

Though this cutter is very powerful, flexible, and simple in operation, it takes 6 cells. The module can be simplified by separating the X, Y, Z cells as they need not be in one common center. This price can be overcome by not having cutter as a separate module. But as a part of the network, in the solid circuit, which along with moving the materials from one module to another module, will also have the cutter architecture to cut the materials in the due course. This also simplifies the architecture of CFPU, and reduces its complexity.

Mixing:

The module is as shown in the FIG. 12. There is slight difference between adding the material, and mixing, the later requires some forced random moment of materials in a container, i.e. mixing. In order to get this, all we can do is to have a rotating rod (53,54), in the cell. The best we can do is to have the mixer in the vertical position, as till now all the operation in the ACS were clean, that means, the piston would wipe all the part of the surface wherever the material can come in to contact. But now, just in the gap where the rods have to rotate, the piston cannot move, and the gap is kept very small (55). In order to do some thing better it is kept in vertical position so all the solid materials can drop down. And for further cleaning after as much material is taken out from piston movement, water is filled and the rods are rotated. There are two mode of mixer operation 1. Slow mode, where gentle mixing of solid and liquid material is required. 2. Fast mode, in which rigorous mixing is done to make thick pastes. Changing the speed of rotation of the rods does this.

Grinding:

The module is as shown in the FIG. 13. Grinding is similar to mixer except it has sharp grinding blades (58) as in kitchen grinder. Both mixer and grinder are better operated in the piston environment than the traditional container, because the pistons can move the materials vertically and get the whole length of material mixed properly. Which was not the case with present day kitchen grinders.

Crushing:

Crushing can be achieved anywhere in the system in any cell, the material needs to be just pressed by the piston against the closed plates of the cell. Blocked motion is used to cause this high force.

Filtering

Filtering can be achieved by slightly modifying the closing plate of the cell (70). The filtered material will be in the cell, and the non-filtered part will be in the solid circuit, so they can be easily separated and moved. And by having an extended plate (71) it can even be stored as shown in FIG. 15.

Moving of Materials:

It is the responsibility of the solid circuit, it is explained in solid circuit section earlier.

Separating Some Quantity:

The cutter unit explained earlier does the job of separating some quantity.

Temporary Storage:

The basic cell serves the job of temporary storage.

Shaping:

Shaping is the most complex operation in ACS, as infinitely different shapes of dishes are available and possible. Also note that the cooking materials once brought to some shape will not remain in that shape unless they are simultaneously processed, i.e. heated, etc. so the shaper needs to be closely associated with cooking unit.

Here this invention proposes a generic way of making any shape. The idea is to make a 3 dimensional structure by filling the materials at every required points of the structure. For that a set of 4 plates (72,73,74,75) are provided as shown in FIG. 16, which will be called a window. The plates when overlapped will make a hole (76) and that hole can be moved anywhere in the plane, and also one can vary the size of the hole to allow bigger materials to pass through. So, by pushing the materials through the hole, and also moving the hole in the required point, a layer of material with the required design can be formed. And by making many such layers one above the other a 3 dimensional structure can be made. Also to allow simple and precise designs a plate called Multi Shape Design Plate (MSDP) as in FIG. 16A is placed below the window plates, which has many pre designed shapes cut in it, and the window mechanism will select, i.e. open for the selected design, and the material, as again can be pushed through the design to get the required shape.

The shaper module integrated with cooking module is as shown in FIG. 18. Considering only shaper module, it has solid circuit interface (92,93) to CFPU, to get the materials in and out of the shaper. The material is pushed by the top compressing chamber 1 of the shaper. The material pushed will take shape by the window and MSDP plate arrangement (87) below it. It is then put in to the lower chamber 2. Which can be further processed there or can be taken back to CFPU by the lower in & out cells (93). The other pistons (95,95A) in the opposite side do the pushing back work for materials.

Layering:

The shaper can also do the job of layering. Layering is putting different materials in the required positions, whereas shaper is used to put any material in required position in 3 Dimension. So by putting different materials in different places one can make layers of materials.

Auxiliary-Process:

Input—Loading Materials:

Since the materials to be loaded in to ACS are in the varying sizes, it needs to be brought in to size, less than the size of the cell. So input is basically, big size to small size converter, by cutting the bigger units to less than cell size. Also ACS doing this part than the users themselves cutting and loading saves lots of effort for the user. And Input being a bigger unit than cell size allows more amount of material could be loaded in less number of iterations of loading. The input module is as shown in FIG. 17. The material is loaded in to the system from the top (79). The top portion is chosen so that things can be easily loaded by dropping in. And all the plates (80,81,84) and parallelepiped (82), pushing piston (83) act on the material in order, so that effectively a bulk material is first cut to one slice by pushing by piston (78) and cut by plate (80), that slice is then cut to bar by plate (81), and the bar is pushed by piston (83) and it is cut to small cubes by plate (84), and is moved on to solid circuit (85), for CFPU to take over.

The reason why input should be connected to CFPU than directly to storage is, The material needs some pre-processing, like cutting etc before storing, Also storage unit is generally placed in remote location and user interface and display etc can only be in CFPU unit. And since storage is a compact unit, its storage and access by users directly, would require huge space. So it's better such unit is connected and managed through CFPU.

Measuring:

There are three ways the materials for cooking can be measured. It is Volume measurement, weight measurement and the count measurement. Weight measurement is to have an electronic weighing unit in the cell. But the most used method is the volume measurement, which the basic cell inherently has. The materials to be measured are put in to cell, and compressed to know the displacement of the piston. By knowing the change in torque or the amount of force it exerted, when simply tried to compress one can stop at the increased torque point and know the amount of volume it takes. Most of the materials can be done with this, but there are certain materials, which need to be kept intact until they are used. And all the things cannot be compressed to know their amount. An example is Egg. So one will need the count measurement, for things, which cannot be cut, nor deformed until used. Here the requirement is that they are fed to the system N number of units at a time in a certain order or fashion, and the system takes the count, what the user entered.

There is packaging technique for fragile materials, so that things are not spoiled or broken or crashed while handling in ACS, until they are used. These are kept intact and given a strong package to stand the operations of ACS. It is to give fragile materials like egg, a package that will make it strong to withstand the normal movement in ACS. And can only be opened when it is cut or compressed.

Cleaning:

Cleaning is both for Materials and System. Cleaning is an important procedure in the cooking system, as in cooking one deals with spicy and sticky substances, cleaning become very important before the next cooking can take place. So water is always kept filled in the solid circuit of ACS when it is not in use. Some cleaning agent or ultrasonic vibrators could also be used to take off any stain in the system. A better technique would be to circulate hot water in CFPU. Also one can use some dummy materials to pass through the CFPU. And the waste is thrown out in waste outlet. One important consideration is, we should have a non-stick coating in the inner surface of solid circuit, like non-stick pans.

But if the materials are too spicy, sticky and oily, to store this all in the storage unit is a real messy thing. One possible solution is to have packaged storage. I.e. the material to be stored is first packaged in to a plastic cover. And then move the package through SSOTT to storage in cells. This ensures a clean operation. And when it comes to using take the entire package and use how much ever you want to use it and make another package for whatever is remaining and store it back. This method ensures clean operation in storage but requires a packaging unit to be part of CFPU system. Also it can give packaged food anyway.

Water Inlet:

The water supply pipe is permanently connected to ACS, it is first connected to a pipe and then it is passed through a cell, where the required amount of water is pumped. The inherent mechanism of piston and cylinder of the cell easily does it.

Heating Appliance:

Heating by electricity is best suited for ACS, as one just needs to turn a switch on. But gas being most economical, it should be supported. The gas can be lit by heating electric coil to start. One needs to rotate a knob to the required amount to regulate the gas flow or heating. This can be easily achieved by the cable motion control. A temperature sensor is also provided to know what exactly is the heat supplied to the system. A pressure heating unit by gas is as shown in FIG. 14.

Cooked Dish Outlet:

It has very important artistic value. Because people would want to receive the food in a more beautiful way than just things being dropped down on their plates. Both the shaped dish and mixed dish are presented on a tray. Which can be tilted either to get the solid material or let the liquid material flow down.

Measured Outlet:

For things like coffee, tea, liquid or even for other food items, if one needs to have a measured amount of food to be served, like in hotels a measured output is required. It is nothing but one cell projected outside where things will be measured and ejected.

Waste Outlet:

Is again a cell outlet, which would be always directed towards a waste-collecting bag.

Cooking:

It is also necessary to provide a way for parallel cooking. Heating is the one, which takes most of the time. So one can have many things put together and collectively heat them. So one needs to have many chambers for cooking. And these chambers can't be of cell size, as it requires bigger spaced cooking vessels. Therefore, the Shaping module is integrated to do cooking along with the shaping job. Also shaping needs to be closely associated with cooking, because things once shaped can't retain their shape unless they are simultaneously heated or processed to maintain the shape. So it makes a better choice to integrate the cooking unit with the shaping unit, which is already has sufficient space to carry out cooking. The cooking module must be bi-directional, because the cooked food may be used as input for further processing or can be used to store back the cooked food to refrigerated-storage module. The cooking module integrated with shaping unit is as shown in FIG. 18.

It has an extra space in the middle (chamber 2) and the lower push piston still falls down by one more cell length (chamber 4). With this, in this model, one gets 4 chambers for cooking. Each chamber is a cell size high, and the plane is a square with each side can be 3 times the size of cell. With this one can make 4 different dishes cooked simultaneously. One can choose some or all the chambers to cook one or more dishes, depending on the amount of each dish. There are two places where the materials can be put or taken back (92,93) to CFPU. The chamber No. 2 has a piston plate at the backside (96A, not shown), which will exit the cooked food from the front to out side world. And a tray will collect the output. With this both shaped and mixed dish can be collected without altering the shape to present to the user. The material in chamber 2 can be directly pushed out to the user. The material in chamber 1 can be pushed to chamber 2 and out putted. The material in chamber 3 cannot be pushed to chamber 2 unless chamber 4 has the same dish. So in that case food in chamber 3 has to be put back to CFPU for temporary storage and food in chamber 4 is pushed to chamber 2 and out-putted and the material is got back from CFPU to out it.

Water Immersed Heating:

We shall now consider the different types of cooking. Materials, including water can be put in from CFPU by the in & out ports (92,93) to lower chambers 3,4, and the heating is done electrically by the coils (89A) attached to lower push-up piston. The open close plates (90) are opened so as to make the adjacent chambers to form a single chamber to heat large quantity of food.

Pan Frying/Raw Heating:

The chamber 1 is used, to get the materials in from CFPU. And is pushed down to make shaping or layering in chamber 2. The lower heating piston (89A) is held below the chamber 2 and is heated. To heat the materials on topside, the top-heating piston (89) is pressed down on the materials. The window plates can make mix or layers of materials by moving them.

Oil Frying:

Oil is filled in to the system by top inlets. And by opening all the lower chamber plates (90) a big chamber is created to fry more materials. And the heater in the lower piston plate (89A) is heated. And the shaped materials are dropped down in to the oil. Once the material to be fried is fried, the lower piston is moved down and the oil filter (91) in the 4^{th} chamber is closed to filter the oil. All the oil comes down to 4^{th} chamber and the fried material stays in chamber 3 and is taken in to CFPU.

Steam/Pressure Heating:

The materials are fed in from either of the inlets in to some or all the chambers. And the steam inlet window (97) is opened at the side, for the heated steam to come from outside to enter the cooking unit. The steam window acts as exhaust while frying. Now only important thing is to have the whole unit pressure tight, or encapsulate the whole unit of cooking in to a pressure tight seal. One can make 4 different dishes in this arrangement simultaneously.

Hot Air Heating/Microwave:

Hot air heating is same, as pressure steam heating instead of supplying steam hot air needs to be supplied. Along with the steam duct one of the material inlet is used to circulate the hot air in side the cooking chamber. And the heating of the hot air has to be done in circulating the air in a radiator grill mesh. And a fan is needed to circulate the air. Hot air heating is needed in case of dishes like biscuits etc. With this we have covered all the most common forms of cooking.

Design and Architecture of SSOTT:

The design of the ACS is ruled by space constraints, i.e. to make it as small as possible. But given the required space for both storage and CFPU, it is going to be a very bulky structure which is not only difficult to transport and handle, also most of the kitchens can't accommodate such big unit. So the solution is to split the storage and CFPU and connect them by SSOTT. Small Solid Object Transport Tube (98) has a flexible tube (100), which has a cell (99) inside it and carries the materials to and from STORAGE and CFPU. It is moved by a cable pair (101) and has load/unload ports (102) at its ends, SSOTT (98) is as shown in FIG. 19.

Such a system allows a great deal of flexibility, in treating storage as a separate entity other than food processing. Now storage being a separate unit, it can be placed at a remote available space. And many such storage units can be connected to one food-making unit. And having one big storage can serve many of the processing units. One can have a network of storage units. Also one can separate storage for refrigerated storage. And not just in ACS, SSOTT can help grocery shops use the most optimal storage method. And such many storage units can be placed in the back-ground with just having a SSOTT connection at the front end. And it's possible to access all the materials from all over the shop and get it in a single point of access. Following is the material exchange protocol between entities using SSOTT to exchange materials. The protocol elements are as below,

| | |
|---|---|
| PUT(X) | //put material X given in through SSOTT cell. |
| GET(X,M) | //get X material of M quantity. |
| GETQ(X) | //gives the total amount of material X available |
| GET_CELL(N) | // will get the content stored in the cell |
| | numbered N. |
| PUT_CELL(N) | // will put the content |
| | in to the cell numbered N. |
| GET_CELL_M(N,M) | // will get the content of quantity |
| | M stored in the cell numbered N. |
| PUT_CELL_M(N,M) | // will put the content of quantity |
| | M in to the cell numbered N. |
| IS_QNTY(N) | // will tell how much quantity of material |
| | in the cell N. |
| SIG_REAH( ) | // a signal to indicate the arrival for material |
| | to CFPU. |
| TTL_CELL( ) | //will indicate the total number of cells. |

Rules are provided to exchange more detailed but standard information between them. Protocol between primary storage with secondary storage, chain or network of storage units, server storage to connect to Multiple CFPU's etc.

Design and Architecture of CFPU:

CFPU—CENTRAL FOOD PROCESSING UNIT. Is the heart of ACS. It does all the job of ACS. Other than storage and access the rest of the job is solely carried by the CFPU. CFPU is primarily a Solid Circuit connecting different modules in it. CFPU can be made in various designs, connecting various modules. However the main objectives are, to reduce the solid circuit complexity as low as possible, to make it as compact as possible, and to keep the most interacting modules close by.

The complexity and space of CFPU can be reduced by clubbing some operation in to the same units as considered here. For example, one can club Cutter, Solid Circuit network, and Temporary storage. It is also possible to club Cooking module, shape, and filter modules. The total system components are, input, cook+shape+filter, n/w+cut (104), temp store (108), mix (106), grind (105), SSOTT connection (103), water in (107), waste out (110), measured out (109). Out of which the primary modules of design are input, cook, cut, mix, grind, SSOTT connection, the rest of the modules follow the consequence of these design it may be necessary to provide a rack of 3 SSOTT connections, wherein 2 are for primary storage and 1 for refrigerated storage. Also if the SSOTT is not watertight or the storage unit is simplified for solid storage, then it should be possible to store few materials inside the CFPU only, by having a small temp storage space in it. One of the possible architecture of CFPU is as shown in FIG. 20.

Programming ACS:

Programming ACS is like programming a computer. The material is loaded in to the input module, along with entering its name/code. The system knows what are the cells which are used, which are empty, and which material is in which cell. Either it can add to already half full cell, or select a new empty cell, so that when a material comes, the system finds the best place to keep it in one or more cells.

Even the different SSOTT route is chosen in case of more than one SSOTT if it is connected to refrigerated storage. So having the system known which material is where, when a program to cook one particular dish is selected, the system picks the right material, and then takes the right amount. And through SSOTT passes to CFPU. The CFPU does the required processing by taking many more materials and adding together all the materials in to one container. Or it can do cutting, mixing, grinding and shape in to required shape and heat it. And can exit the dish in either shaped out or measured out let. Or it can still be stored until the exit key is pressed by the user. Or in case if the material cant be stored as it is, in the cooking unit or in normal storage the system can time out and move the material to REFRIGERATED STORAGE through SSOTT.

Interface for Programming:

It is mainly a concern of programming mechanical systems, i.e. of mechanical/electrical interfaces. The major part of the interface is with “GIRISH” Box, as programming ACS is mostly controlling the moving parts of ACS. We need to move all the pistons and plates and disks to their exact position. The controlling is done with Embedded computing system. The system has to maintain Motion Control Table, Input Signal Table, Output Signal Table, System State Table, Interrupt Table, Storage Table, to motor rpm, torque, rotation counter etc.

Operating System for ACS. (ACS-OS):

Operating system gives life to ACS hardware. It has a collection of programs. It maintains all the activity of the ACS. It provides a shell user interface. It controls all the hardware. It takes the application programs through shell, which were written in cooking language. And executes them. It maintains all the tables of information of ACS like, Motion Control Table, Input Signal Table, Output Signal Table, System State Table, Interrupt Table, Storage Table, etc. It knows which material should be placed in which storage cell and retrieved for each cooking program. It allows many programs to be scheduled, and many dishes to be cooked simultaneously. Even when there are programs running, it allows the shell to run and let the user interact with the system to monitor or load input materials etc. The shell interacts with user and ACS-OS. It will give all graphical display, current state of all the system parameters, amount of storage and their available materials etc. It allows many programs to run in parallel. And it maintains the resource sharing among different programs. It has utility programs, for user to just instruct cutting or storing etc. it has library of many common tasks done by the system. And most importantly it provides API's (Application programming interface) to the programs, which are running on it. And it schedules the cooking. Does maintenance and cleaning by calling their procedure programs. And so on till user just has to give a plain text written in cooking language to cook a dish, rest is taken care by ACS-OS.

Application Programming Interface for ACS:

```
Here are some API's list for ACS programming.
MoveP( part_no, displacement, direction);
    //The fundamental API is to move a particular part
    //Moves a particular part. displacement is the required amount
    //of movement. And tell in which direction.
```

| | |
|---|---|
| Reset(part_no); | // brings the device to original position or initial position |

Grind(speed, ON/OFF); //for the grinder to grind at what speed and ON/OFF.

| | |
|---|---|
| Mix(speed, ON/OFF) | // while doing grind or mix even its pistons |
| | //or plates are free to move |

```
Cut(axis, length, divisions);  // axis says, in which direction, x,y,z.
    //and length says given that material how long from the entry point it
    //should be cut. And divisions say that length should be cut in to how
    //many parts. cut can also be implemented using MoveP.
```

| | |
|---|---|
| Move(A,B); | // moves the entire content of A to B. B may be already having |

```
    //some thing in it. A an B can be storage addresses in STORAGE
    //UNIT or tmp storage unit address in CFPU. all possible storage
    //place of cell size in the CFPU solid //circuit should have a
    //number. Move can be implemented by MoveP.
```

| | |
|---|---|
| HeatOn(type, temp); | // heating made on. type is, to say, steam, raw heat, hot air, etc |

```
    //also to say which or both the top and bottom heating coils.
    // temp is to tell at what temperature.
```

| | |
|---|---|
| HeatOff(type); | //heat is turned on for the type or of the device. |

```
    //there has to be separate timer run, interrupts should be
    //set to maintain the duration of heat.
//Shape/layer has to implemented using MoveP for each requirement.
```

| | |
|---|---|
| IN( ); | //activate Input module to accept input of materials. |
| OUT(A); | //Out puts the dish either in shaped out or measured out. |

| | |
|---|---|
| MEASURE(A); | //measure the content of material in the addressed cell, |
| | //by piston compression. |
| GetCurrTorque( ); | //returns the current torque/load of the system. |

GetCurrPosition(part); //gets the current position of the part.

| | |
|---|---|
| GetMotorRPM( ); | //returns rotation per minute or speed of driving motor. |
| SetRotCount(x); | //sets the counter X to zero. |
| GetRotCount(x); | // returns the counts made by rotation counter of the motor to X. |
| StopRotCount(X); | //stops the counter X from being further incremented and |

```
    //remains in its value indicating the total rotation made by the motor for
    //X counter. Which will be associated to measure the displacement of any part.
```

| | |
|---|---|
| Status(part); | //gets the status generated signal from a sensor, temp, |
| | //position, overload, etc, |
| INT(num); | //the electric hardware system autonomously sends some signals |
| | //to programs with a number |

Cooking Language for ACS:

Though lower level of API's and other routines can be called in the program. And any machine could cook any dish. But cooking in it self is independent of the nature of any machine. So, Cooking Language is a generic way of instructing the machine or telling some body uniquely, to cook some dish. The cooking language is as below.

CELL Z; // CELL is a keyword, which declares a storage unit of cell and name it Z.

TAKE(Y,X,Z); // TAKE is a keyword. Y is the code for that material. And X is the amount in volume. And put it in a container Z. When the machine gets this instruction it gets the address from its table, about where the material is kept. And measures it to take X amount of material, and keeps it in a temporary storage cell Z.

ADD(Z,Q); // ADD is a keyword: It puts together the contents of cell Z to already present contents of Q.

CUT(Z,D,N); // CUT is a keyword. It says the contents Z has to be cut along D direction to N number of equal parts.

MIX(Z,R); // MIX is a keyword it says mix the content in the cell Z. to a degree R. where R is a degree of mixing which we will define later, ex: as soft, regular, through etc.

GRIND(Z); // GRIND is a keyword it says Grind the content in the cell Z.

MOV(Z,Q); // Move is a keyword. It says move the complete content in the cell Z to Q.

SEPARATE(Z,M,Q); // SEPARATE is a keyword. It says separate M amount of material from the cell Z, and put it in Q.

FILTER(Z,F,Q); // FILTER is a keyword, it says filter the contents of Z through a mesh whose mesh size area equals F, and put the material which passed through such filter in a cell Q.

SHAPE(Z,M,H); // SHAPE is a keyword. It says take the M amount of substance in the cell Z and make it in to a standard shape numbered as H.

HEAT(Z,TYPE,TIME,TEMP); // HEAT is a keyword. It says heat the content in Z. in a TYPE as indicated by TYPE number ex: as steam, fry, dry etc. and at a temperature TEMP, for a duration of TIME.

IN(M); //IN is a keyword. It means take a material coded as M, and store it. It doesn't talk about the quantity, the system takes how much ever the supply is and stores it. The exact quantity comes in to play when we cook, that is by using TAKE command.

OUT(Z); //OUT is a keyword. It says, out the content of cell Z to outside world. With these and some more enhancements, one can write all the recipes as a sequence of instruction. This makes up a generic set of instructions and can be given to either a cook or cooking system. Here is an example for cooking rice for one person.

| | |
|---|---|
| TAKE(RICE,100,Z) | // RICE is defined to be a code number, |
| | assigned for rice. |

//100 is 100 grams of rice to be put in cell now for our sake called Z.
TAKE(WATER,100,Q) //gets water in to cell Q.

| | |
|---|---|
| ADD(Q,Z) | //adds the content of Q in to already present of |
| | content of Z. |
| TAKE(SALT,10,Q) | //gets some salt in to Q |
| ADD(Q,Z) | //add salt to Z. |
| MIX(Z,1) | //mix rice, water and salt, in mild degree. |

HEAT(Z,STEAM,15,100) //syntax is HEAT(Z,TYPE,TIME,TEMP)

| | |
|---|---|
| OUT(Z) | // out puts cooked rice |

User Interface for ACS:

This section talks about software interface to the user.

Input:

First, while loading the materials the input key is pressed, so the input open/close plate opens, and the material is loaded, and key for the material code is selected, this selection is done by a tree kind of drop down menu. Selecting all the classes and subclasses or the code/name can be directly entered to it. Then optionally, quantity or number of pieces of material is entered. And a enter key is pressed to accept the material in to the system. The open/close plate closes and the material is processed according to the program. This program is not a dish making program but a utility program of the ACS-OS.

Cooking:

Arrow key for menu, sub menu, of tree fashioned selection display of dishes is displayed, or the user can key in the name of the dish, or code for the dish. The selection can go like, as vegetarian, non-vegetarian, diet food, north Indian, south Indian, Chinese, spice, dry, based on geographical location, there local favorite food so on. And once the selection is made, it is required to specify the quantity of food to be prepared for. That's all. The display tells the time and other things to user. And beep is sent when the dish is ready.

Configuration of Programmed Dish for the Proposition of Food:

It is important to give the freedom for the user to change the composition of the already programmed food, i.e. to change the taste, other properties, to change amount of heating, to substitute different materials and to make in different shapes etc. This part of the program can be made part of the common library or ACS-OS than to have each programs to code for it. And the programs can also take control of such choices. Another way is to allow the user to edit the source code of the dish, which is in cooking language to modify the content or process. And finally to allow the user directly write code to cook, and save that code.

Monitoring—Maintenance of System—Materials—Processes—Error Messages and Beeps:

Display the stored materials, their quantity, and their code number, physical cell location, current stage of cooking. What is being cooked or even to see in the display how things are being cooked. And to allow various types of configure and controlling of the system. Also for indicating the non-availability of materials, water, gas, etc. system errors, any emergency indications and to indicate finishing of cooking etc.

Parallel Processing ACS:

Since “GIRISH” Box allows each device to move independent of other device, to cook a dish, the program can be simultaneously be picking some material from storage unit. Or the user can load some materials through INPUT in to ACS while the system could be cutting or grinding some thing, or heating some dish, or while the dish is being cooked one can access some material from storage, and set the pre-processing ready for the next cooking or if it can be heated with same type like steam heat, then it can be simultaneously cooked. The only constraints in doing things in parallel is the modules like, cutting, grinding etc, would be occupied by other process, so process has to share the modules.

CD Drive, Internet, Mobile Phone, Computer Interface to ACS:

If people want to have a dish of some continent, they can buy CD's which will have recipe programs written in cooking language. People on the move, or in theater, can instruct the ACS with their mobile phone, to cook a particular dish in half an hour, by the time they reach home. Or they can even give the next instruction to store it in fritz if they are late, which the system would timeout and do it any way, when its been programmed to do so. Or people, through a computer can instruct to cook some dish, can see all the content stored. Can have complete user interface, and they can even monitor the ACS.

1-30. (canceled)

31. A storage system for storing materials, comprising:
an array of closely packed rotatable disks, mounted on a common axis, each disk being divided into sectors packed with cells arranged in an arc or line form, leaving one free sector space in between, to enable access to the cells; and
a set of sector-slot-open-close plates for selecting cells in each disk, wherein access of the cells along the array is done by an arm mechanism, and wherein disk selection is done by a swinging movement of said arm mechanism and rotating a desired disk, wherein each of said sectors is controllable to come in the path of the arm swing, each cell is selectable by controlling an amount of arm swing.

32. A storage system as claimed in claim 31, wherein said cells are small and fixed sized cells for storage of all different materials and wherein said system is adapted to allow software selection of the cells for storage.

33. A common storage system as claimed in claim 31, wherein said arm mechanism includes with two cells having cylinder and piston arrangement for moving, storing and collecting the materials.

34. A central food processing unit in an automatic cooking and material handling system, comprising:
at least one cell for material processing and cooking;
an input unit;
at least one of a cutting unit, a mixer unit, a grinder unit, a crusher unit, a shaper unit, a layering unit, a filter unit, a heating unit, and any combinations thereof;
an outlet unit;
a solid circuit for providing a path for the material to move from one point to another point in the central food processing unit; and
a moving unit for moving the material.

35. The central food processing unit of claim 34, wherein said moving unit includes at least one small solid object transport tube, said transport tube including a mechanism for transporting small solid objects through a flexible tube, wherein a cell is disposed inside the tube to carry solid objects inside it, the cell moving from end to end and movement of the cell being controlled by a pair of cables attached to it.

36. The central food processing unit as claimed in claim 34, wherein the at least one cell includes a piston-cylinder arrangement with an open-close plate in the front.

37. The central food processing unit as claimed in claim 34, wherein the at least one cell has means to implement pre-processing steps including mixing, filtering, grinding, heating, and crushing, wherein the mixing unit includes a cell provided with a rotating rod, the filtering unit includes a mesh in the plate, the grinding unit includes a rotating grinding blades, the steam heating unit is a cell provided with gas or electric heater and the crushing unit is a cell having a closed plate and a piston to enable crushing.

38. The central food processing unit as claimed in claim 34, wherein the solid circuit includes a hollow tubular path for the movement of materials.

39. The central food processing unit as claimed in claim 34, wherein the cutter unit is a combination of 7 cells in 3 x-y-z dimensions, each having a plate, to provide 3 degrees of cutting, and also for separating the cut materials.

40. The central food processing unit as claimed in claim 34, wherein the input unit is a common unit to load different sized materials to convert to sizes lesser than cell size, wherein bulk material is first cut in to slices, the slices are then cut into bars, and the bars are cut into small cubes, to load on to the solid circuit.

41. The central food processing unit as claimed in claim 34, wherein the shaping unit is a general-purpose three-dimensional material shaper with window mechanism and multi shape design plate, wherein the said window mechanism includes a set four plates arranged to move on their tracks, in such a way that a hole is formed in a desired place and of variable size, wherein the multi shape design plate is a plate placed parallel to the window mechanism having many desired predefined cutouts, and wherein the selection of a cutout is done by said window mechanism.

42. The central food processing unit as claimed in claim 34, wherein the cooking unit includes a plurality of chambers for multiple heating and multi processing, along with the necessary inlet and outlet in combination with the shaping unit.

43. The central food processing unit as claimed in claim 34, further comprising at least one of:
means to schedule many processes of cooking;
means to share central food processing unit modules;
means to provide an environment for cooking programs to run;
means to give API's for programs;
means to give a user interface;
means to maintain all the states;
a storage table; and
means to monitor the operations, including utility programs to act as an operating system for automatic cooking system.

44. The central food processing unit as claimed in claim 34, further comprising:
means to instruct an automatic cooking system to cook any dish with a cooking language.

45. A multiple motion control mechanism for providing multiple, parallel, independent, programmable, motion control, comprising:
a common driving unit for driving said multiple motion control mechanism;
at least one rotating drum; and
a cable pair, wherein one end of the cable pair is fixed and wound on said at least one rotating drum, and the other end is attached to an object to be moved, wherein movement of the object is controlled by rotation of the at least one rotating drum, said rotation being driven by a common shaft of said common driving unit.

46. The multiple motion control mechanism as claimed in claim 45, further comprising:
a parallel processing motion controller that provides at least seven states of operation of the drum, said seven states being: blocked clockwise, blocked anti-clockwise, blocked stop, free, non-blocking clockwise, non-blocking anti-clockwise, and non-blocking stop.

47. the multiple motion control mechanism as claimed in claim 46, wherein said parallel processing motion controller includes 3 shafts, wherein a middle shaft is stationary and the other two shafts are rotated in clockwise and anti-clockwise directions, wherein the cable wound drum is attached with gearing mechanism with the other shafts, the gears being not directly connected to the shafts and the rotation of the gears is caused by having coupling and decoupling disks which slide while rotating on their shafts, the disks have both toothed and frictional contacts with the side surfaces of the gears, by choosing the appropriate disk to couple,

48. The multiple motion control mechanism as claimed in claim 45, further comprising:
a parallel processing motion controller that provides at least four states of operation including blocked clockwise motion, blocked anti-clockwise motion, blocked stop, and free states of motion.

49. The multiple motion control mechanism as claimed in claim 45, further comprising:
a single processing motion controller including a shaft and two toothed contact disks disposed on the sides of the rotating drum, the direction of rotation of the drum being changed by changing the rotation of the shaft, and wherein the coupling disks are connected to have only two states of toggle, so that it can provide blocked clockwise, blocked anti-clockwise, blocked stop, states of motion.

50. The multiple motion control mechanism as claimed in claim 45, further comprising:
a power transfer mechanism for the multiple motion controller consists of a motor, a make & brake clutch, with or without a direction changing gear, having a common optical rotation counter and torque measurement unit.

51. The multiple motion control mechanism as claimed in claim 45, further comprising:
a gear switching mechanism having bi-stable toggling arms which is activated by an electrical relay mechanism or x-y positioner with a notch projection to toggle the bi-stable toggling arms.

52. The multiple motion control mechanism as claimed in claim 45, further comprising:
a pneumatic motion controller with a programmable multiple motion control system based on dual fluid pipes.
